(19) United States
(12) Patent Application Publication
(10) Pub. No.: US 2026/0045717 A1
(43) Pub. Date: Feb. 12, 2026

(54) POWER CONNECTOR SYSTEM FOR CIRCUIT CARD ASSEMBLY

(71) Applicant: Tyco Electronics (Shanghai) Co., Ltd., Shanghai (CN)

(72) Inventors: Wenxia Zhou, Shanghai (CN); YuQiang Zhao, Shanghai (CN); Wei Yao, Shanghai (CN)

(21) Appl. No.: 18/808,141

(22) Filed: Aug. 19, 2024

(30) Foreign Application Priority Data
Aug. 7, 2024 (CN) 202411083027.1

(51) Int. Cl. H01R 12/72; H01R 12/75; H01R 13/631

(52) U.S. Cl. CPC H01R 12/722; H01R 12/75; H01R 13/631

(57) ABSTRACT

A power connector system includes a circuit card assembly having a circuit board with a mounting area, power conductors at the mounting area, and signal conductors at the mounting area. A board power connector includes a board housing with a cavity open at the front and a bottom mounted to the circuit board of the circuit card assembly at the mounting area. The board power connector includes board power contacts held by the board housing and received in the cavity. The power connector system includes a cable power connector mated to the board power connector with a cable housing holding cable power contacts terminated to corresponding power cables and mated to the board power contacts and holding cable signal contacts mated with the signal conductors of the circuit board.

### CROSS REFERENCE TO RELATED APPLICATIONS

This application claims benefit to Chinese Application No. 202411083027.1, filed 07-Aug.-2024 the subject matter of which is herein incorporated by reference in its entirety.

### BACKGROUND OF THE INVENTION

The subject matter herein relates generally to power connector systems for circuit card assemblies.

Circuit card assemblies have components that require power to operate. Typically, power is delivered to the circuit card across the interface with the card edge connector that receives the circuit card. However, providing power contacts at the interface increases the number of contacts needed at the interface. When adhering to standard interfaces, the number of contacts may not be increased to accommodate a larger power requirement. Additionally, the contact pads are typically small and thus have low current capacity. To overcome the problems with conventional circuit card assemblies, some circuit card assemblies provide a separate power connector mounted to the circuit card that mates with a cable power connector to supply power to the circuit card. There is a need to provide signaling with the cable power connector. However, known cable power connectors having signal contacts have an increased profile and footprint. The addition of the signal contacts increases the width and/or height of the cable connector and the board mounted connector, which reduces airflow across the circuit card assembly and reduces the real estate on the circuit card for other electrical components.

A need remains for a low profile, small footprint power connector system for a circuit card assembly having signal contacts and power contacts.

### BRIEF DESCRIPTION OF THE INVENTION

In one embodiment, a power connector system is provided and includes a circuit card assembly that includes a circuit board having a mounting area, power conductors at the mounting area, and signal conductors at the mounting area. The circuit card assembly includes a board power connector that has a board housing including a top, a bottom, a front and a rear. The board housing includes a cavity open at the front. The bottom is configured to be mounted to the circuit board of the circuit card assembly at the mounting area. The board power connector includes board power contacts held by the board housing and received in the cavity. Each board power contact includes a mating end and a terminating end. The terminating ends of the board power contacts are configured to be terminated to the power conductors of the circuit board. The circuit card assembly includes a cable power connector configured to be mated to the board power connector. The cable power connector has a cable housing that includes a top, a bottom, a front and a rear. The cable power connector includes power cables extending from the rear. The cable power connector includes cable power contacts held by the cable housing. The cable power contacts are terminated to corresponding power cables. The front of the cable housing and the mating ends of the cable power contacts are plugged into the cavity of the board housing to mate the cable power contacts with the board power contacts. The cable power connector includes cable signal contacts arranged at the bottom of the cable housing for mating with the signal conductors of the circuit board when the cable power connector is mated with the board power connector.

In another embodiment, a power connector system for a circuit card assembly is provided. The power connector system includes a circuit card assembly that includes a circuit board and a board power connector mounted to the circuit board configured to be mated with a cable power connector. The circuit board includes an upper surface and a lower surface. The circuit board includes a mounting area. The circuit board includes power conductors at the mounting area. The circuit board includes signal conductors at the mounting area. The signal conductors include signal contact pads on the upper surface configured to be mated with cable signal contacts of the cable power connector. The board power connector includes a board housing includes a top, a bottom, a front and a rear. The board housing includes a cavity open at the front. The bottom is configured to be mounted to the circuit board of the circuit card assembly at the mounting area. The power connector system includes board power contacts held by the board housing and received in the cavity. Each board power contact includes a mating end and a terminating end. The mating ends of the board power contacts configured to be mated with cable power contacts to the cable power connector. The terminating ends of the board power contacts configured to be terminated to the power conductors of the circuit board. The board power contacts are located above the signal contact pads of the circuit board in the cavity for mating with the cable power contacts and the cable signal contacts of the cable power connector when the cable power connector is plugged into the cavity.

In a further embodiment, a power connector system for a circuit card assembly is provided. The power connector system includes a cable power connector configured to be mated to a board power connector mounted to the circuit card assembly. The cable power connector includes a cable housing that includes a top, a bottom, a front and a rear. The cable housing includes a nose at the front configured to be plugged into the board power connector. The cable housing includes a platform at the bottom. The cable housing includes power contact channels in the nose. The cable housing includes signal contact channels in the platform. The cable power connector includes cable power contacts held in corresponding power contact channels. The cable power contacts include mating ends configured to be mated to board power contacts of the board power connector. The cable power contacts include terminating ends. The cable power connector includes power cables terminated to the terminating ends of the cable power contacts and extending from the rear. The cable power connector includes cable signal contacts held in corresponding signal contact channels of the platform at the bottom of the cable housing. The cable signal contacts include mating ends and terminating ends. The mating ends are exposed along the bottom for mating with signal contact pads on a circuit card of the circuit card assembly when the cable power connector is mated to the circuit card assembly. The cable power connector includes signal cables terminated to terminating ends of the cable signal contacts.

### BRIEF DESCRIPTION OF THE DRAWINGS

FIG. 1 is a top perspective view of a power connector system in accordance with an exemplary embodiment showing a cable power connector poised for mating with a board power connector of a circuit card assembly.

FIG. 2 is a top perspective view of the power connector system in accordance with an exemplary embodiment showing the cable power connector mated with the board power connector of the circuit card assembly.

FIG. 3 is a top view of the power connector system in accordance with an exemplary embodiment.

FIG. 4 is a side view of the power connector system in accordance with an exemplary embodiment.

FIG. 5 is a bottom perspective view of the power connector system in accordance with an exemplary embodiment showing the cable power connector mated with the board power connector of the circuit card assembly.

FIG. 6 is a front perspective view of a portion of the board power connector in accordance with an exemplary embodiment.

FIG. 7 is a front perspective view of the cable power connector in accordance with an exemplary embodiment.

FIG. 8 is a bottom perspective view of the cable power connector in accordance with an exemplary embodiment.

FIG. 9 is a perspective view of a portion of the cable power connector showing the cable signal contacts and portions of the cable power contacts in accordance with an exemplary embodiment.

FIG. 10 is a perspective view of a portion of the cable power connector showing the cable signal contacts mated to the signal conductors of the circuit board in accordance with an exemplary embodiment.

FIG. 11 is a cross-sectional view of the power connector system in accordance with an exemplary embodiment showing the cable power connector mated to the board power connector and the circuit board.

FIG. 12 is a sectional view of the power connector system in accordance with an exemplary embodiment showing the cable power connector mated to the board power connector and the circuit board.

### DETAILED DESCRIPTION OF THE INVENTION

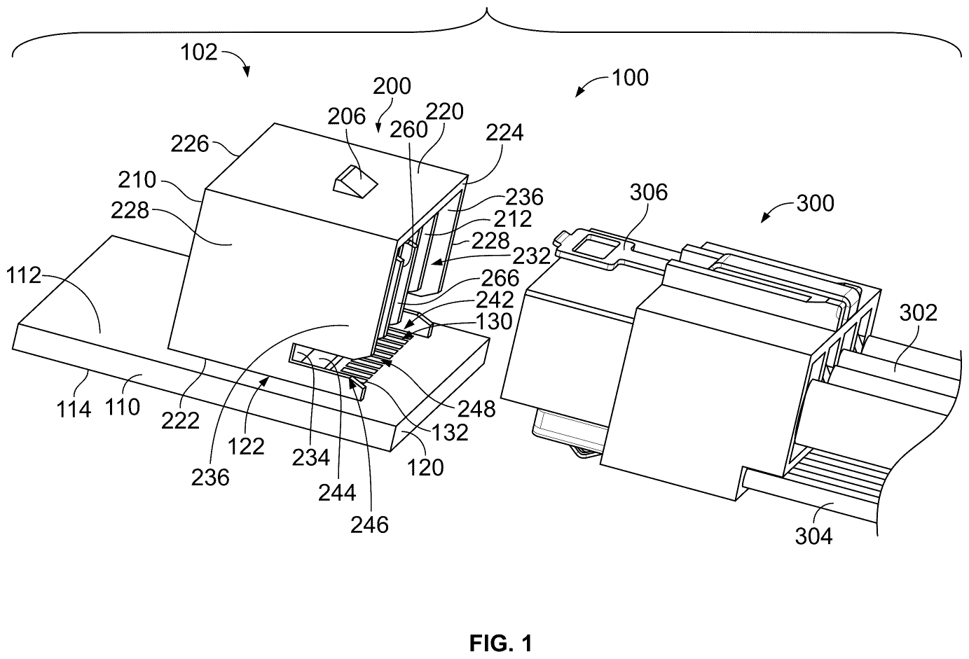

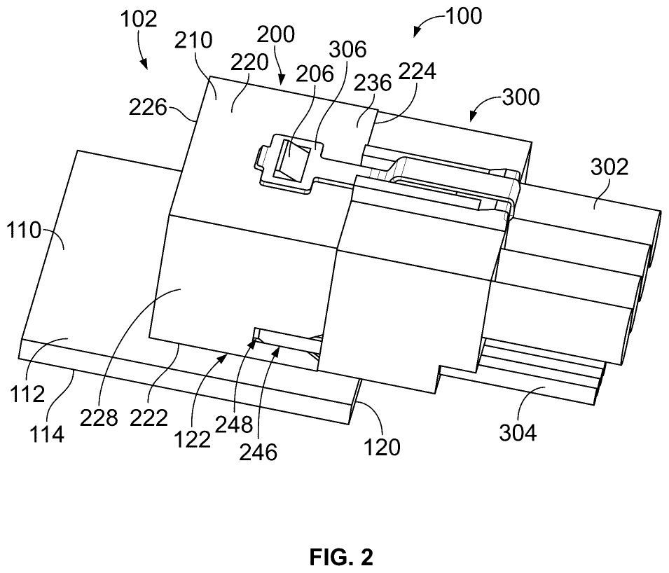

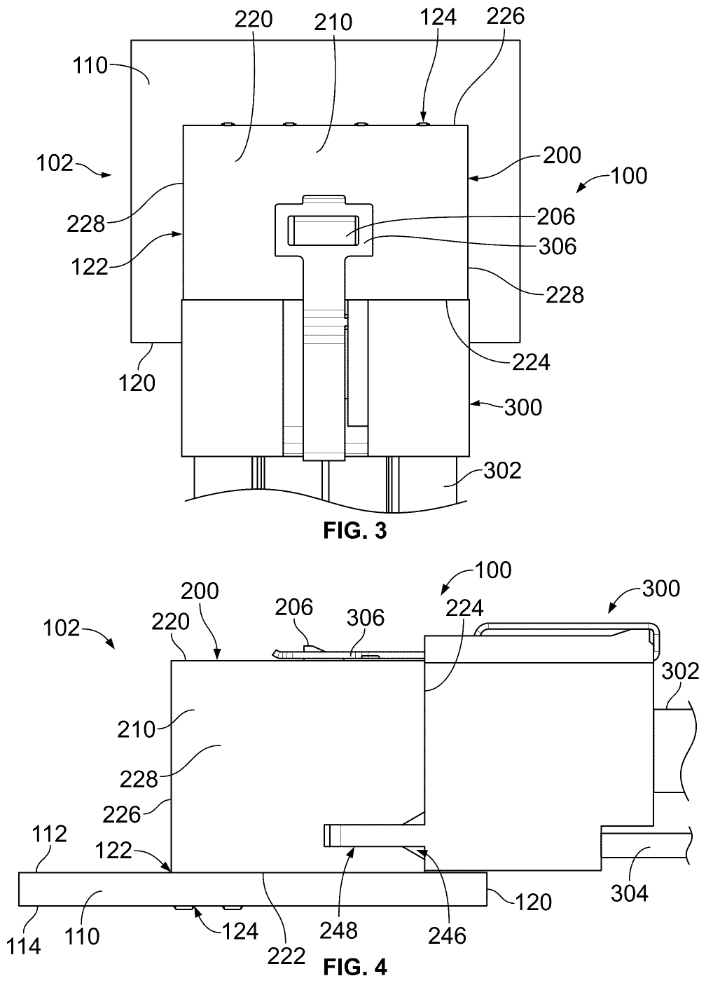

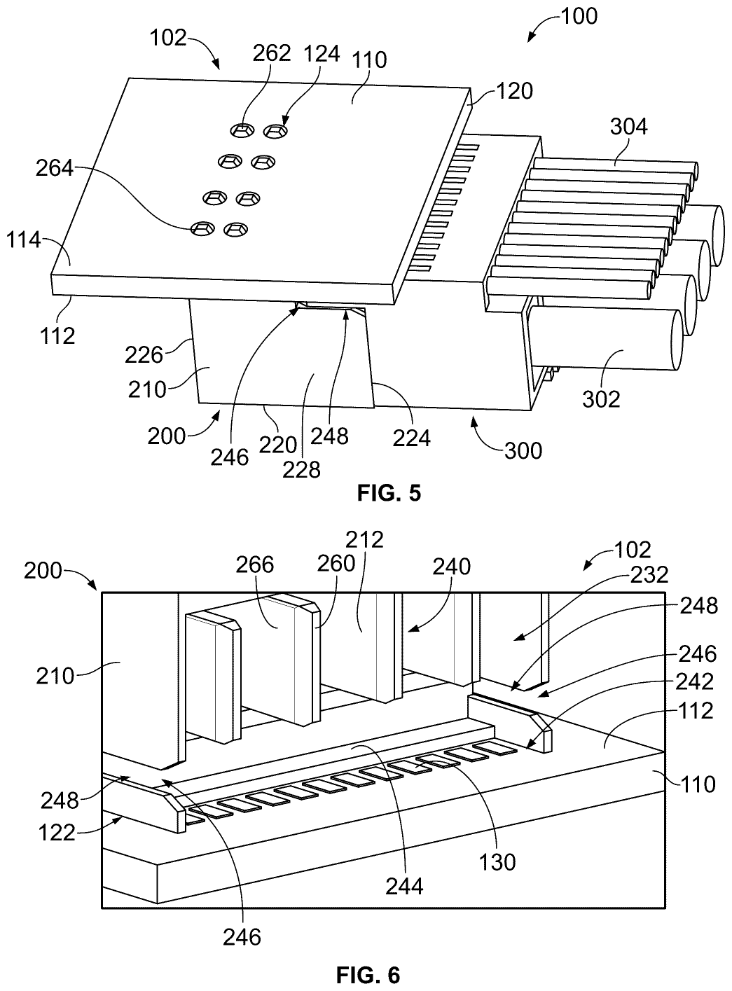

FIG. 1 is a top perspective view of a power connector system 100 in accordance with an exemplary embodiment showing a cable power connector 300 poised for mating with a board power connector 200 of a circuit card assembly 102. FIG. 2 is a top perspective view of the power connector system 100 in accordance with an exemplary embodiment showing the cable power connector 300 mated with the board power connector 200 of the circuit card assembly 102. FIG. 3 is a top view of the power connector system 100 in accordance with an exemplary embodiment. FIG. 4 is a side view of the power connector system 100 in accordance with an exemplary embodiment. FIG. 5 is a bottom perspective view of the power connector system 100 in accordance with an exemplary embodiment showing the cable power connector 300 mated with the board power connector 200 of the circuit card assembly 102.

In an exemplary embodiment, the power connector system 100 is a cable to board power delivery system. The power connector system 100 provides power to the circuit card assembly 102. In various embodiments, the circuit card assembly 102 may be a peripheral component interconnect express (PCIe) assembly; however, the circuit card assembly 102 may be another type of electrical assembly in alternative embodiments. Having the power connector system 100 supply power to the circuit card assembly 102 reduces the need for power transfer across other interfaces, such as across a card interface with a card edge connector and the circuit board. As such, significantly more power can be transferred to the circuit board than is possible if only a card edge connector is used to transmit power to the circuit board. Optionally, the power connector system 100 may entirely eliminate the need for power transfer across the interface between the card edge connector and the circuit board.

The circuit card assembly 102 includes a circuit board 110 and the board power connector 200 mounted to the circuit board 110. The circuit board 110 includes a top surface 112 and a bottom surface 114. The circuit board 110 is a printed circuit board having circuits defined by traces, vias, pads, and the like of the circuit board 110. The circuit card assembly 102 may include one or more electrical components (not shown) mounted to the circuit board 110, such as processors, memories, and the like. In an exemplary embodiment, the circuit board 110 includes an edge 120.

The circuit board 110 includes a mounting area 122 proximate to the edge 120. The board power connector 200 is mounted to the circuit board 110 at the mounting area 122, proximate to the edge 120. The circuit board 110 includes a power connection at the mounting area 122 for providing power transfer between the cable power connector 300 and the circuit card assembly 102 and a signal connection at the mounting area 122 for providing data transfer between the cable power connector 300 and the circuit card assembly 102. In an exemplary embodiment, the circuit board 110 includes power conductors 124 (FIG. 5) configured to be electrically connected to power contacts of the cable power connector 300 forming the power connection for the circuit card assembly 102. In an exemplary embodiment, the circuit board 110 includes signal conductors 130 (FIG. 1) configured to be electrically connected to signal contacts of the cable power connector 300 forming the signal connection for the circuit card assembly 102. The power conductors 124 and the signal conductors 130 are formed by circuits of the circuit board 110, such as traces, pads, vias and the like.

The power connector system 100 includes the board power connector 200 and the cable power connector 300. The cable power connector 300 is electrically connected to the power conductors 124 through the board power connector 200 to supply power to the circuit card assembly 102.

The cable power connector 300 is directly electrically connected to the signal conductors 130 of the circuit board 110 when the cable power connector 300 is mated to the board power connector 200. The cable power connector 300 includes power cables 302 and signal cables 304 for power and data communication. The cable power connector 300 includes a latch 306 for securing the cable power connector 300 to the board power connector 200.

The board power connector 200 is mounted to the circuit board 110 at the mounting area 122. The cable power connector 300 is configured to be plugged into the board power connector 200. The board power connector 200 includes a latching element 206 configured to interface with the latch 306 for securing the cable power connector 300 to the board power connector 200. The board power connector 200 may include guide features to guide mating with the cable power connector 300. In an exemplary embodiment, the board power connector 200 is a right angle connector having a mating end configured to be mated to the cable power connector 300 and a mounting end perpendicular to the mating end configured to be mounted to the circuit board 110. Other types of connectors may be used in alternative embodiments. In an exemplary embodiment, the board power connector 200 and the cable power connector 300 have low- profiles for increased airflow and tighter packaging of electrical components.

The circuit board 110 includes the power conductors 124 and the signal conductors 130 at the mounting area 122 proximate to the edge 120. The signal conductors 130 enhance the operation of the power connector system 100 by providing signal lines and signaling between the cable power connector 300 and the circuit board 110. The signal conductors 130 provides direct connection between the cable power connector 300 and the circuit board 110. The signal lines may be used for coding to determine the type of cable power connector 300 and power cable coupled to the board power connector 200. Optionally, the signaling may be used to control the flow of power through the power connector system 100. For example, the signal conductors 130 may be used as part of a sense circuit for controlling power supply to the circuit card assembly 102. The signal conductors 130 may be used for data communication between one or more components of the circuit card assembly 102 and a remote device or component such as but not limited to a power supply.

The board power connector 200 is mounted to the circuit board 110 proximate to the signal conductors 130. In an exemplary embodiment, the board power connector 200 covers the area above the signal conductors 130 such that when the cable power connector 300 is plugged into the board power connector 200 the cable power connector 300 is mated to the signal conductors 130. As such, the power connection and the signal connection for the cable power connector 300 may be mated simultaneously, such as with the single plugging/mating action. In the illustrated embodiment, the power conductors 124 are defined by vias through the circuit board 110 that receive power contacts of the board power connector 200. In the illustrated embodiment, the signal conductors 130 are defined by signal contact pads 132 (FIG. 1) on the circuit board 110 and/or traces or vias extending from the signal contact pads 132. In an exemplary embodiment, the signal conductors 130 are contained within the footprint of the board power connector 200. For example, the signal conductors 130 are positioned between the power conductors 124 and the edge 120. As such, the signal conductors 130 do not increase the overall footprint of the mounting area 122. The signal conductors 130 are contained within an area already dedicated to the board power connector 200 and thus the addition of the signal lines to the power connector system 100 and the circuit card assembly 102 do not add to the overall footprint or size of the mounting area 122.

With additional reference to FIG. 6, which is a front perspective view of a portion of the board power connector 200, the board power connector 200 includes a board housing 210 holding board power contacts 212 (FIG. 1). The board power contacts 212 are configured to be electrically connected to the circuit card assembly 102 and the cable power connector 300. The board power contacts 212 may be used to mechanically connect the board power connector 200 to the circuit board 110. The board power connector 200 may additionally or alternatively include mounting tabs or other securing features for mounting the board power connector 200 to the circuit board 110.

The board housing 210 is a dielectric housing, such as a plastic housing. The board housing 210 may be manufactured by a molding process to form the board housing 210. In an exemplary embodiment, the board housing 210 is box shaped. The board housing 210 includes a top 220 and a bottom 222 opposite the top 220. The board housing 210 includes a front 224 and a rear 226 opposite the front 224. The board housing 210 includes sides 228 extending between the top 220 and the bottom 222 and extending between the front 224 and the rear 226. The board housing 210 may have other shapes in alternative embodiments. The board housing 210 includes the latching feature 206 along the top 220 configured to interface with the latch 306 to secure the cable power connector 300 to the board power connector 200. The latching feature 206 may be at other locations in alternative embodiments.

The board housing 210 includes a cavity 232 configured to receive the mating end of the cable power connector 300. The board power contacts 212 extend into the cavity 232 to mate with the cable power connector 300. The cavity 232 is open, such as at the front 224, to receive the mating end of the cable power connector 300. For example, the cable power connector 300 is configured to plug into the cavity 232 to electrically connect with the board power contacts 212. In the illustrated embodiment, the cavity 232 is rectangular shaped; however, the cavity 232 may have other shapes in alternative embodiments. In an exemplary embodiment, the board housing 210 includes an end wall 234 at the rear of the cavity 232 and shroud walls 236 extending forward of the end wall 234 to the front 224 of the board housing 210. For example, the shroud walls 236 may extend along the top and sides of the cavity 232. The bottom of the cavity 232 may be open, such as to allow access to the signal conductors 130 of the circuit board 110.

In an exemplary embodiment, the board housing 210 includes power contact channels 240 that receive the corresponding board power contacts 212. The power contact channels 240 may pass through the end wall 234 to allow access to the cavity 232. The power contact channels 240 may be open at the rear 226, such as for rear loading the board power contacts 212 into the power contact channels 240. The power contact channels 240 may be open at the bottom 222, such as to allow connection of the board power contacts 212 to the circuit board 110.

In an exemplary embodiment, the board housing 210 includes a window 242 at the bottom 222. The window 242 provides access to the top surface 112 of the circuit board 110 and the signal conductors 130 at the mounting area 122. The window 242 may be formed by a cutout or opening in the bottom wall of the board housing 210. The window 242 may extend an entire width of the board housing 210, such as between the opposite right and left sides 228 of the board housing 210 (for example, between the walls at the right and left sides). In an exemplary embodiment, the board housing 210 includes a ledge 244 rearward of the window 242. The ledge 244 is formed by a portion of the bottom wall of the board housing 210. The ledge 244 may provide a seat or resting surface for a portion of the cable power connector 300, such as for locating the cable power connector 300 relative to the board power connector 200 and/or the circuit board 110 for mating with the signal conductors 130 of the circuit board 110.

In an exemplary embodiment, the board housing 210 includes guide features 246 to guide mating with the cable power connector 300. In the illustrated embodiment, the guide features 246 include guide slots 248. The guide slots 248 are formed in the side walls. Optionally, the guide slots 248 may be located proximate to the bottom 222. The guide slots 248 are open at the front to receive guide features of the cable power connector 300. Other types of guide features may be used in alternative embodiments.

In an exemplary embodiment, the board power contacts 212 are stamped and formed contacts. Each board power contact 212 includes a mating end 260 and a terminating end 262. Optionally, the board power contacts 212 may be a right-angle contact having the mating end 260 perpendicular to the terminating end 262. The mating end 260 is configured to be mated with the cable power connector 300. The terminating end 262 is configured to be terminated to the circuit board 110.

In an exemplary embodiment, the board power contacts 212 includes a solder tail 264 at the terminating end 262 configured to be soldered to the circuit board 110. In the illustrated embodiment, the solder tail 264 is configured to be through mounted to the circuit board 110, such as in the corresponding power conductor 124 (for example, via) of the circuit board 110. Alternatively, the solder tail 264 may be surface mounted to the circuit board 110. In other various embodiments, the terminating end 262 may include a compliant pin configured to be press-fit into the circuit board 110.

In an exemplary embodiment, the board power contacts 212 includes a blade 266 at the mating end 260. In various embodiments, the blade 266 extends forward of the end wall 234 into the cavity 232. The blade 266 is contained within the envelope of the board housing 210. Optionally, the blade 266 is arranged within the cavity 232 such that the cable power connector 300 is configured to mate to both sides of the blade 266. The blade 266 has a large surface area at both sides for electrical connection with the cable power connector 300. In other various embodiments, the mating end 260 may include a spring beam that is deflectable for mating with the cable power connector 300.

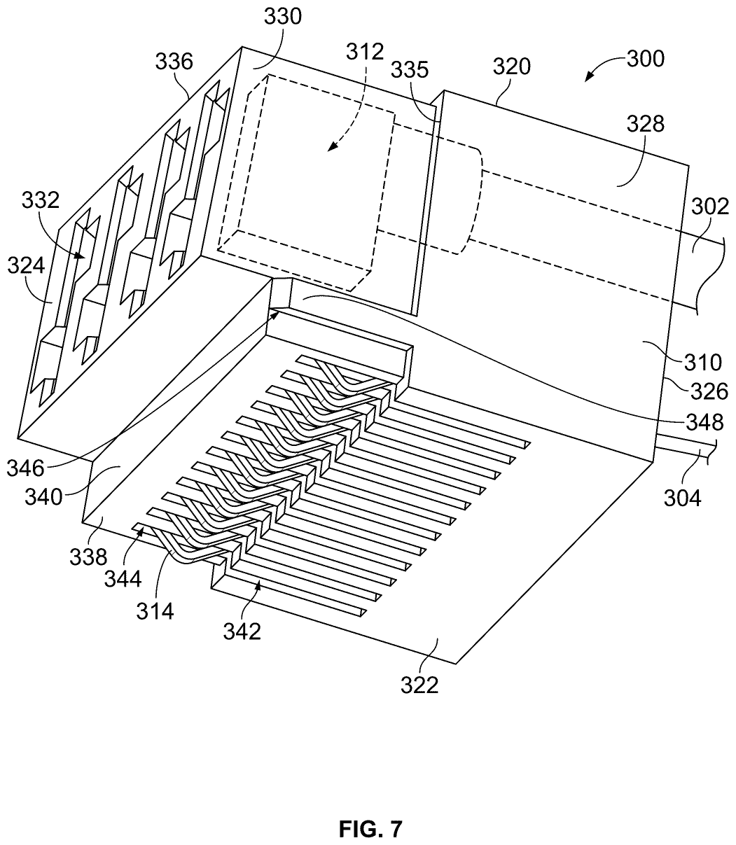

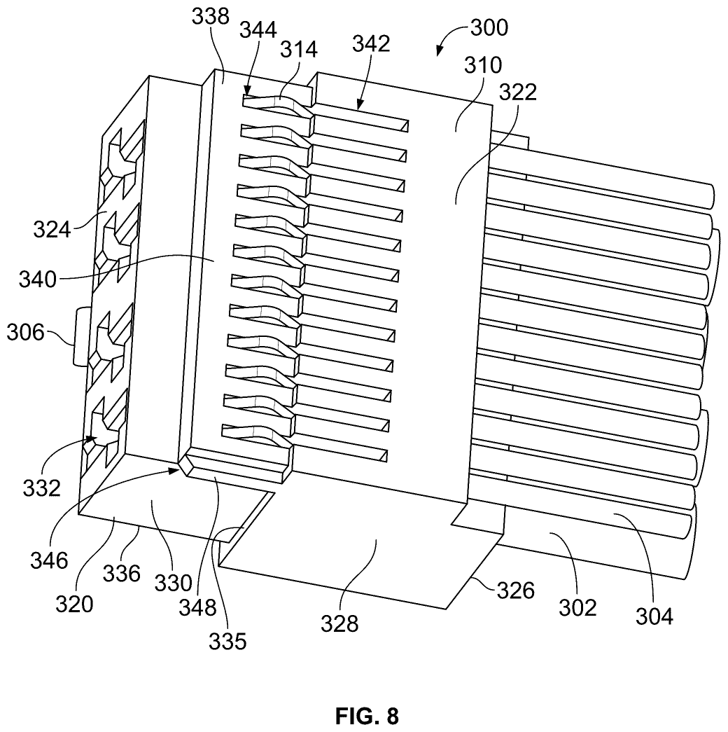

FIG. 7 is a front perspective view of the cable power connector 300 in accordance with an exemplary embodiment. FIG. 8 is a bottom perspective view of the cable power connector 300 in accordance with an exemplary embodiment.

The cable power connector 300 includes a cable housing 310 holding cable power contacts 312 (shown in phantom in FIGS. 7 and 8) and cable signal contacts 314. The cable power contacts 312 are configured to be electrically connected to the power cables 302 and the board power contacts 212 (shown in FIG. 6). The cable signal contacts 314 are configured to be electrically connected to the signal cables 304 and the signal contact pads 132 defining the signal conductors 130 of the circuit board 110. The cable signal contacts 314 are configured to be directly connected to the circuit board 110 via the signal contact pads 132.

The cable housing 310 is a dielectric housing, such as a plastic housing. The cable housing 310 may be manufactured by a molding process to form the cable housing 310. In an exemplary embodiment, the cable housing 310 is generally box shaped. The cable housing 310 includes a top 320 and a bottom 322 opposite the top 320. The cable housing 310 includes a front 324 and a rear 326 opposite the front 324. The cable housing 310 includes sides 328 extending between the top 320 and the bottom 322 and extending between the front 324 and the rear 326. The cable housing 310 may have other shapes in alternative embodiments. The cable housing 310 supports the latch 306 along the top 320 configured to interface with the latching feature 206 (shown in FIG. 1) to secure the cable power connector 300 to the board power connector 200.

The cable housing 310 includes a nose 330 at the front 324 configured to hold the cable power contacts 312. The cable housing 310 may include multiple noses or silos holding individual cable power contacts 312 in alternative embodiment. The nose 330 includes contact channels 332 that receive the cable power contacts 312. The contact channels 332 are open at the front 324 to receive the board power contacts 212 (shown in FIG. 6) when the cable power connector 300 is mated with the board power connector 200. The nose 330 is sized and shaped to fit within the cavity 232 (shown in FIG. 6) during mating to electrically connect the cable power contacts 312 with the board power contacts 212. In the illustrated embodiment, the nose 330 is rectangular shaped; however, the nose 330 may have other shapes in alternative embodiments. In an exemplary embodiment, the nose 330 extends forward from a base wall 335 that extends between an upper wall 336 and a lower wall 338 of the cable housing 310. The lower wall 338 extends along the bottom 322 and the upper wall 336 extends along the top 320.

In an exemplary embodiment, the cable housing 310 includes a platform 340 at the bottom 322 of the cable housing 310. The platform 340 extends to the front 324 of the cable housing 310. The platform 340 supports the cable signal contacts 314. In an exemplary embodiment, the platform 340 includes signal contact channels 342 that receive corresponding cable signal contacts 314. The cable signal contacts 314 are held in the signal contact channels 342. The platform 340 has a lower surface at the bottom 222. The signal contact channels 342 have slots 344 at the lower surface. Portions of the cable signal contacts 314 extend through the slots 344 below the lower surface to face the circuit board 110 and interface with the signal conductors 130. The cable signal contacts 314 may be provided at other locations in alternative embodiments.

In an exemplary embodiment, the cable housing 310 includes guide features 346 to guide mating of the cable power connector 300 with the board power connector 200. In the illustrated embodiment, the guide features 346 include guide ribs 348. The guide ribs 348 extend along the side walls. Optionally, the guide ribs 348 may be located proximate to the bottom 322. The guide ribs 348 may extend along the platform 340. The guide ribs 348 are sized and shaped to fit in the guide slots 248 of the board power connector 200 to guide mating. Other types of guide features may be used in alternative embodiments.

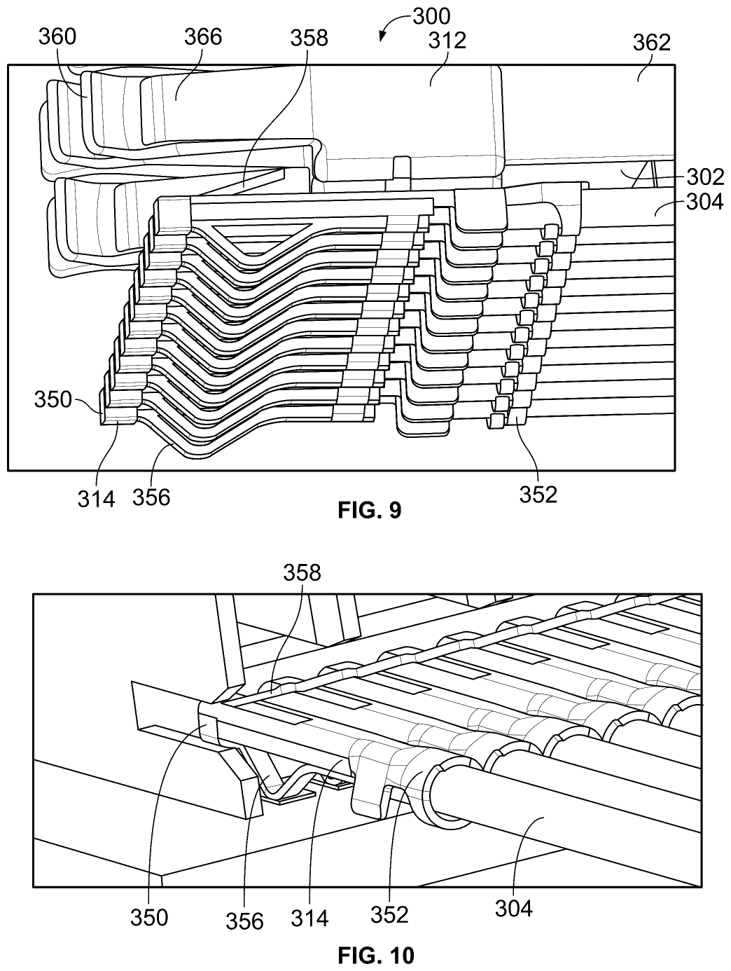

FIG. 9 is a perspective view of a portion of the cable power connector 300 showing the cable signal contacts 314 and portions of the cable power contacts 312 in accordance with an exemplary embodiment. FIG. 10 is a perspective view of a portion of the cable power connector 300 showing the cable signal contacts 314 mated to the signal conductors 130 of the circuit board 110 in accordance with an exemplary embodiment.

In an exemplary embodiment, the cable signal contacts 314 are stamped and formed contacts. Each cable signal contact 314 includes a mating end 350 and a terminating end 352. The mating end 350 is configured to be mated with the signal conductors 130 of the circuit board 110. For example, the mating end 350 is configured to be directly mated to the signal contact pad 132. The terminating end 352 is configured to be terminated to the signal cable 304. In an exemplary embodiment, the cable signal contact 314 includes a crimp barrel at the terminating end 352 configured to be crimped to the signal cable 304; however, the terminating end 352 may be terminated by other means in alternative embodiments. The signal cables 304 extend from the rear 326, such as from the rear of the platform 340.

In an exemplary embodiment, each cable signal contact 314 includes a spring beam 356 at the mating end 350 configured to be mated with the board signal contact 214. The spring beam 356 is deflectable and extends below the lower surface of the platform 340 to interface with the board signal contact 214. In the illustrated embodiment, the spring beams 356 are V-shaped having a point forming a mating interface. However, in alternative embodiments, the spring beams 356 may be cantilevered beams having the mating end at the distal ends of the spring beams. Other types of mating ends may be used in alternative embodiments.

In an exemplary embodiment, the cable signal contact 314 includes a load beam 358 opposite the spring beam 356. The load beam 358 is configured to engage the cable housing 310 to press the cable signal contact 314 downward to force the spring beam 356 against the circuit board 110. The load beam 358 may be a cantilevered beam with the distal end engaging the cable housing 310. The lead beam 358 may be used to retain the cable signal contact 314 in the cable housing 310, such as to resist pull out of the cable signal contact 314 from the cable housing 310.

The cable power contacts 312 are located within corresponding contact channels 332 for mating with the board power contacts 212 when the cable power connector 300 is mated with the board power connector 200. In an exemplary embodiment, each cable power contact 312 extends between a mating end 360 and a terminating end 362. The mating end 360 is configured to be mated with the corresponding board power contact 212. The terminating end 362 is configured to be terminated to the corresponding power cable 302. In an exemplary embodiment, the terminating end 362 includes a crimp barrel configured to be crimped to the corresponding power cable 302. In an exemplary embodiment, each cable power contact 312 includes spring beams 366 at the mating end 360 for mating with the corresponding board power contact 212. Optionally, each cable power contact 312 includes a plurality of spring beams 366 for mating with the board power contact 212. The spring beams 366 may be configured to engage both sides of the corresponding board power contact 212.

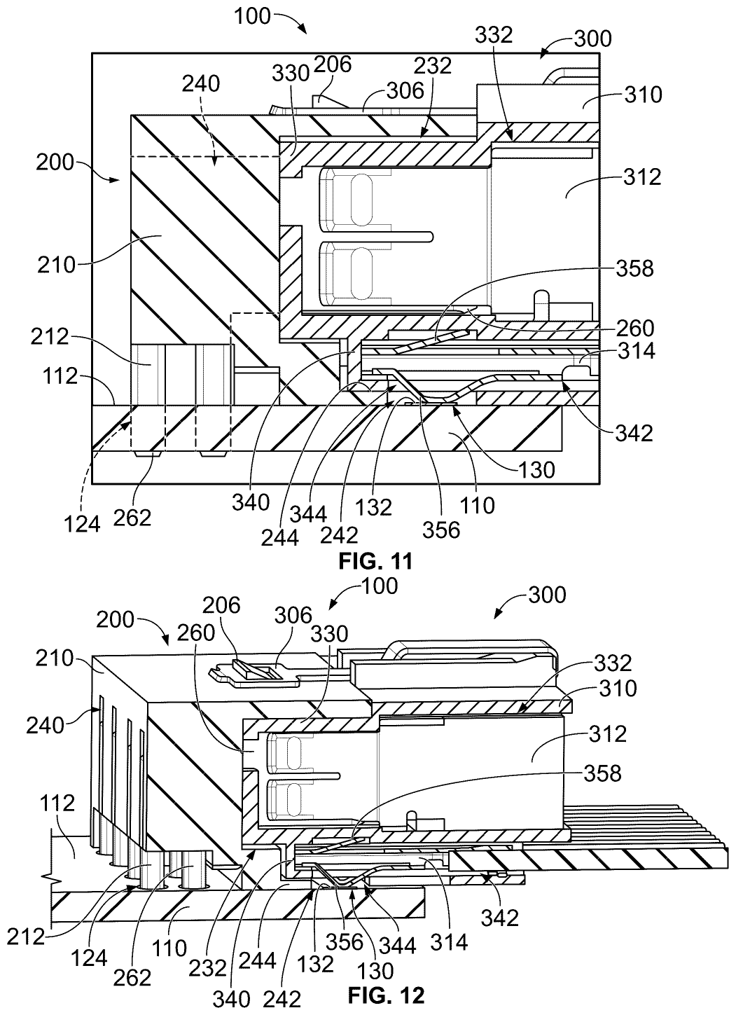

FIG. 11 is a cross-sectional view of the power connector system 100 in accordance with an exemplary embodiment showing the cable power connector 300 mated to the board power connector 200 and the circuit board 110. FIG. 12 is a sectional view of the power connector system 100 in accordance with an exemplary embodiment showing the cable power connector 300 mated to the board power connector 200 and the circuit board 110.

When assembled, the board power connector 200 is mounted to the top surface 112 of the circuit board 110. The board housing 210 is coupled to the top surface 112. The board housing 210 covers the signal conductors 130. For example, the window 242 is aligned with the row of signal conductors 130. The board power contacts 212 are received in the corresponding power contact channels 240. The mating ends 260 of the board power contacts 212 extend into the cavity 232 for mating with the cable power connector 300. The board power contacts 212 are terminated to the power conductors 124. For example, the terminating ends 262 are press fit and/or soldered to the power conductors 124.

When assembled, the cable power contacts 312 are received in the corresponding contact channels 332 in the nose 330 and the cable signal contacts 314 are received in the corresponding contact channels 342 in the platform 340. The load beam 358 engages the cable housing 310. The load beam 358 presses the cable signal contact 314 in a downward direction. The load beam 358 may be used to retain the cable signal contact 314 in the contact channel 342, such as to prevent pullout. The spring beam 356 passes through the slot 344 at the bottom of the platform 340 to an exterior of the cable housing 310, such as below the bottom of the cable housing 310, to interface with the circuit board 110.

During mating, the mating end of the cable power connector 300 is plugged into the cavity 232 at the front of the board power connector 200. For example, the nose 330 is plugged into the cavity 232. The latch 306 is latchably coupled to the latching element 206. The mating ends 260 of the board power contacts 212 are loaded into the contact channels 332 at the front of the cable housing 310. The cable power contacts 312 are mated to the board power contacts 212 to electrically connect the cable power contacts 312 to the circuit board 110. During mating, the platform 340 is plugged into the cavity 232. The spring beams 356 are mated with the signal contact pads 132 to electrically connect the cable power connector 300 to the circuit board 110. The spring beams 356 are compressible. The spring beams 356 are configured to be compressed and/or deformed between the cable housing 310 and the circuit board 110 to ensure a reliable electrical connection between the cable power connector 300 and the circuit board 110. A direct signal path is formed between the cable power connector 300 and the circuit board 110 to create a reliable electrical path to the circuit board 110. A direct signal path is formed between the cable power connector 300 and the circuit board 110 without the need for separate signal contacts held in the board power connector 200, which reduces the complexity and cost of the board power connector 200.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A power connector system comprising:
a circuit card assembly including a circuit board having a mounting area, power conductors at the mounting area, and signal conductors at the mounting area, the circuit card assembly including a board power connector having a board housing including a top, a bottom, a front and a rear, the board housing including a cavity open at the front, the bottom configured to be mounted to the circuit board of the circuit card assembly at the mounting area, the board power connector including board power contacts held by the board housing and received in the cavity, each board power contact including a mating end and a terminating end, the terminating ends of the board power contacts configured to be terminated to the power conductors of the circuit board; and
a cable power connector configured to be mated to the board power connector, the cable power connector having a cable housing including a top, a bottom, a front and a rear, the cable power connector including power cables extending from the rear, the cable power connector including cable power contacts held by the cable housing, the cable power contacts being terminated to corresponding power cables, the front of the cable housing and the mating ends of the cable power contacts being plugged into the cavity of the board housing to mate the cable power contacts with the board power contacts, the cable power connector including cable signal contacts arranged at the bottom of the cable housing for mating with the signal conductors of the circuit board when the cable power connector is mated with the board power connector.

2. The power connector system of claim 1, wherein the signal conductors include signal contact pads on an upper surface of the circuit board exposed in the cavity to mate with the cable signal contacts.

3. The power connector system of claim 1, wherein the board housing includes a window at the bottom exposing the signal conductors at an upper surface of the circuit board.

4. The power connector system of claim 1, wherein the board housing includes a guide feature, the cable housing including a guide feature interacting with the guide feature of the board housing to guide mating of the cable power connector with the board power connector.

5. The power connector system of claim 1, wherein the cable signal contacts include spring fingers having mating interfaces exposed at the bottom of the cable housing to mate with the signal conductors on an upper surface of the circuit board.

6. The power connector system of claim 5, wherein the spring fingers are compressible between the cable housing and the circuit board.

7. The power connector system of claim 5, wherein the board housing includes guide slots and the cable housing includes guide ribs received in the guide slots during mating, the guide slots and the guide ribs holding a vertical position of the cable housing relative to the board housing to compress the spring fingers between the cable housing and the circuit board.

8. The power connector system of claim 1, wherein the board housing includes an end wall and shroud walls extending forward of the end wall to form the cavity, the mating ends of the board power contacts extending forward of the end wall into the cavity for mating with the cable power contacts, the signal conductors of the circuit board including signal contact pads exposed in the cavity forward of the end wall.

9. The power connector system of claim 1, wherein the circuit board includes an edge, the mounting area located proximate to the edge, the signal conductors including signal contact pads on an upper surface of the circuit board proximate to the edge.

10. The power connector system of claim 1, wherein the mounting area does not include a cutout in the circuit board.

11. The power connector system of claim 1, wherein the signal conductors include circuits of the circuit board separate from the board power connector.

12. The power connector system of claim 1, wherein the cable power connector includes signal cables terminated to the cable signal contacts and extending from the rear of the cable housing.

13. The power connector system of claim 1, wherein the cable housing includes a nose at the front and a platform below the nose at the bottom of the cable housing, the nose including power contact channels receiving the corresponding cable power contacts, the platform including signal contact channels receiving the corresponding cable signal contacts.

14. The power connector system of claim 13, wherein the cable signal contacts include spring fingers exposed along a bottom of the platform configured to face an upper surface of the circuit board to interface with the signal conductors of the circuit board.

15. A power connector system for a circuit card assembly, the power connector system comprising:
a circuit card assembly including a circuit board and a board power connector mounted to the circuit board configured to be mated with a cable power connector;
the circuit board including an upper surface and a lower surface, the circuit board including a mounting area, the circuit board including power conductors at the mounting area, the circuit board including signal conductors at the mounting area, the signal conductors including signal contact pads on the upper surface configured to be mated with cable signal contacts of the cable power connector;
the board power connector including a board housing including a top, a bottom, a front and a rear, the board housing including a cavity open at the front, the bottom configured to be mounted to the circuit board of the circuit card assembly at the mounting area;
board power contacts held by the board housing and received in the cavity, each board power contact including a mating end and a terminating end, the mating ends of the board power contacts configured to be mated with cable power contacts of the cable power connector, the terminating ends of the board power contacts configured to be terminated to the power conductors of the circuit board;
wherein the board power contacts are located above the signal contact pads of the circuit board in the cavity for mating with the cable power contacts and the cable signal contacts of the cable power connector when the cable power connector is plugged into the cavity.

16. The power connector system of claim 15, wherein the board housing includes a window at the bottom exposing the signal contact pads at the upper surface of the circuit board to the cavity for mating with the cable power connector.

17. The power connector system of claim 15, wherein the board housing includes an end wall and shroud walls extending forward of the end wall to form the cavity, the mating ends of the board power contacts extending forward of the end wall into the cavity for mating with the cable power contacts, the signal contact pads exposed in the cavity forward of the end wall.

18. The power connector system of claim 1, wherein the circuit board includes an edge, the mounting area located proximate to the edge, the signal contact pads located on the upper surface of the circuit board between the edge and the power conductors.

19. A power connector system for a circuit card assembly, the power connector system comprising:
a cable power connector configured to be mated to a board power connector mounted to the circuit card assembly, the cable power connector comprising:
a cable housing including a top, a bottom, a front and a rear, the cable housing including a nose at the front configured to be plugged into the board power connector, the cable housing including a platform at the bottom, the cable housing including power contact channels in the nose, the cable housing including signal contact channels in the platform;
cable power contacts held in corresponding power contact channels, the cable power contacts including mating ends configured to be mated to board power contacts of the board power connector, the cable power contacts including terminating ends;
power cables terminated to the terminating ends of the cable power contacts and extending from the rear;
cable signal contacts held in corresponding signal contact channels of the platform at the bottom of the cable housing, the cable signal contacts including mating ends and terminating ends, the mating ends being exposed along the bottom for mating with signal contact pads on a circuit card of the circuit card assembly when the cable power connector is mated to the circuit card assembly; and
signal cables terminated to terminating ends of the cable signal contacts.

20. The power connector system of claim 19. wherein the cable signal contacts include spring fingers having mating interfaces exposed at the bottom of the cable housing to mate with the signal contact pads of the circuit board, the spring fingers being compressible between the cable housing and the circuit board.
